(19) United States
(12) Patent Application Publication
(10) Pub. No.: US 2010/0179995 A1
(43) Pub. Date: Jul. 15, 2010

(54) INSTANT MESSAGE FORWARDING TO SELECTABLE ACCOUNTS

(75) Inventor: Tak Yin Wang, Los Altos, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/352,482

(22) Filed: Jan. 12, 2009

(51) Int. Cl. G06F 15/16

(52) U.S. Cl. 709/206

(57) ABSTRACT

Various embodiments are directed towards enabling a user to forward messages, such as IM messages, or other text messages, from a forwarding account to a different account, where messages are received by the recipient account on behalf of the forwarding account, and reply messages are viewed as having been sent by the forwarding account rather than the recipient account. A message sender may send a message towards the intended (forwarding) account. A message forwarding service, based on forwarding rules, determines the recipient account, and forwards the received message towards the recipient account on behalf of the forwarding account. The message forwarding service may receive a reply, and modify a reply header, such that the reply appears to have been sent by the forwarding account, rather than the recipient account.

### TECHNICAL FIELD

Embodiments relate generally to managing message routing, and more particularly, but not exclusively to enabling users to forward messages sent to their messaging account to another user's messaging account, such that the messages are received at the other user's messaging account on behalf of the user, and responses sent to the sender using the other user's account are sent as though they were sent by the user.

### BACKGROUND

The use of communication technologies is steadily on the increase, for both business and personal uses. Today, many people employ Instant Messaging (IM) technologies as a mechanism to stay connected with friends, family, and work. Many people may have multiple IM accounts even from a same IM service provider for different purposes. For example, a person may have one IM account for family and friends, and a different account for use at work. While there may be as many reasons for multiple accounts as people having multiple accounts, at least one such reason is that a person may simply wish to separate work activities from play activities. However, people may still wish to stay in contact with selected other people. For example, when a person moves from one office to another office, and/or from one client device to another client device, they may still want to be able to receive IM messages from their significant others, their employers, of the like. However, telling all these people where to find them each time the person re-locates for a temporary period of time, may be a burden to the person doing the moving as well as to those trying to maintain knowledge of where the person may have re-located.

A typical scenario might be where a worker has taken up temporary work in a co-employee's office. The worker may still want to receive IM messages from their significant other, manager, and/or other specified IM senders. Telling these potential message senders that the worker has re-located may be an inconvenience to the worker, the manager, and/or other potential message sender. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which various embodiments may be practiced;

FIG. 2 shows one embodiment of a client device that may be included in a system implementing various embodiments;

FIG. 3 shows one embodiment of a network device that may be included in a system implementing various embodiment;

FIG. 4 illustrates a logical flow diagram generally showing one embodiment of an overview process for managing message forwarding for a forwarding account to another selectable account;

FIG. 5 illustrates one embodiment of an example menu interface useable to manage message forwarding; and

FIG. 6 illustrates one embodiment of an example message interface for forwarded messages received on behalf of a forwarding account.

### DETAILED DESCRIPTION

Various embodiments now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes various embodiments in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated various embodiments are directed towards enabling a user to forward messages, such as IM messages, and/or other text messages, from a forwarding account to a recipient account, where messages are received by the recipient account on behalf of the forwarding account, and reply messages to the messages are viewed as having been sent by the forwarding account rather than the recipient account. In this manner, a user may have selected messages forwarded, without having the message sender need know where to forward the message. The message sender may send a message towards the intended account. A message forwarding service, based on user definable forwarding rules, determines the recipient account, and forwards the received message towards the recipient account on behalf of the forwarding account. Because the messages are received at the recipient's account, the “guest” user having messages forwarded to the recipient account, need not, in one embodiment, log into their own account on the other user's client device. Such actions then may protect the guest user's password to their own account.

In one embodiment, the forwarding account and recipient account may be managed by different users. In another embodiment, the forwarding account and recipient account may be managed by a same user. In any event, the message forwarding service may receive a reply message to the forwarded message, and modify a header, and/or other portion of the message, such that the reply appears to have been sent by the forwarding account, rather than the recipient account. In one embodiment, the user/owner of the recipient account may cancel or deny acceptance of a forwarded message. Moreover, the forwarding user may establish a forwarding rule that includes a time period and/or other condition upon satisfaction of which results in the forwarding of a message to expire and/or otherwise change.

### Illustrative Operating Environment

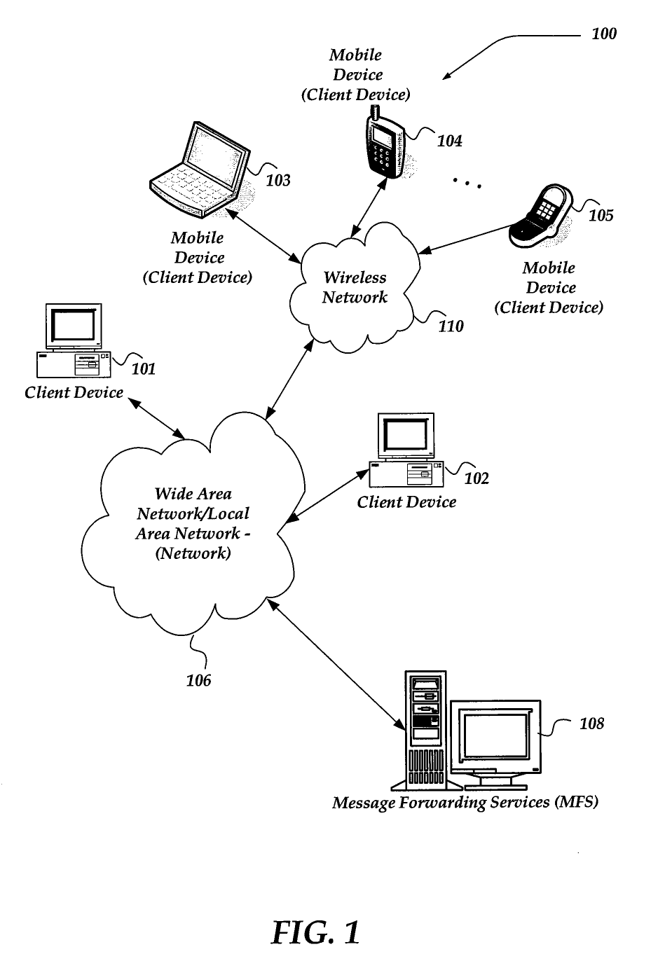

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 106, wireless network 110, client devices 101-105, and Message Forwarding Services (MFS) 108.

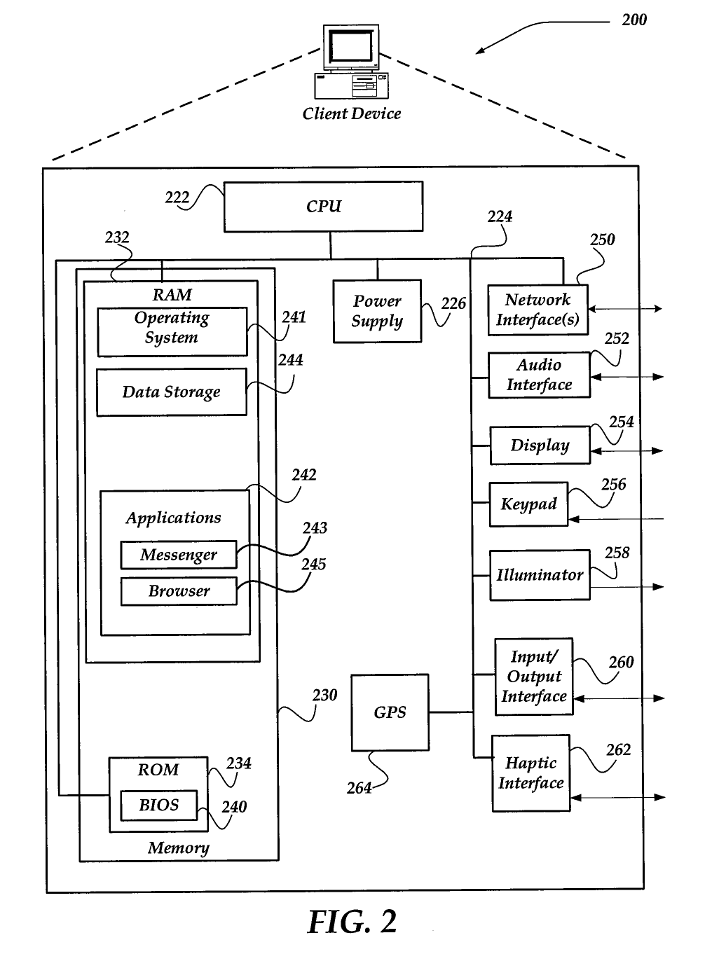

One embodiment of client devices 101-105 is described in more detail below in conjunction with FIG. 2. Generally, however, client devices 103-105 may include virtually any portable computing device capable of receiving and sending a message over a network, such as network 106, wireless network 110, or the like. Client devices 103-105 may also be described generally as client devices that are configured to be portable. Thus, client devices 103-105 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, client devices 103-105 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

Client devices 101-102 may include virtually any computing device capable of communicating over a network to send and receive information, including social networking information, performing graphically generated search queries, or the like. The set of such devices may include devices that typically connect using a wired or wireless communications medium such as personal computers, multiprocessor systems, microprocessor-based or programmable consumer electronics, network PCs, or the like. In one embodiment, at least some of client devices 103-105 may operate over wired and/or wireless network.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send various content. In one embodiment, a user of the client device may employ the browser application to interact with a messing client, such as a text messaging client, an email client, or the like, to send and/or receive messages.

Client devices 101-105 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 101-105 may uniquely identify themselves through any of a variety of mechanisms, including a phone number, Mobile Identification Number (MIN), an electronic serial number (ESN), or other mobile device identifier. The information may also indicate a content format that the mobile device is enabled to employ. Such information may be provided in a network packet, or the like, sent to MFS 108, or other computing devices.

Client devices 101-105 may further be configured to include a client application that enables the end-user to log into an end-user account that may be managed by another computing device, such as MFS 108, or the like. Such end-user account, for example, may be configured to enable the end-user to receive subscribe to one or more search activities, including for example employment searches, online dating searches, product and/or service searches, text messaging, VOIP messaging, email messaging, web browsing, or any of a variety of other networking activities. However, participation in various networking activities may also be performed without logging into the end-user account.

Wireless network 110 is configured to couple client devices 103-105 and its components with network 106. Wireless network 110 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4^{th} (4G) generation radio access for cellular systems, WLAN, Wireless Router (WR) mesh, and the like. Access technologies such as 2G, 3G, 4G and future access networks may enable wide area coverage for mobile devices, such as client devices 103-105 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between client devices 103-105 and another computing device, network, and the like.

Network 106 is configured to couple network devices with other computing devices, including, MFS 108, client devices 101-102, and through wireless network 110 to client devices 103-105. Network 106 is enabled to employ any form of computer readable media for communicating information from one electronic device to another. Also, network 106 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 106 includes any communication method by which information may travel between computing devices.

Additionally, communication media typically embodies computer-readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

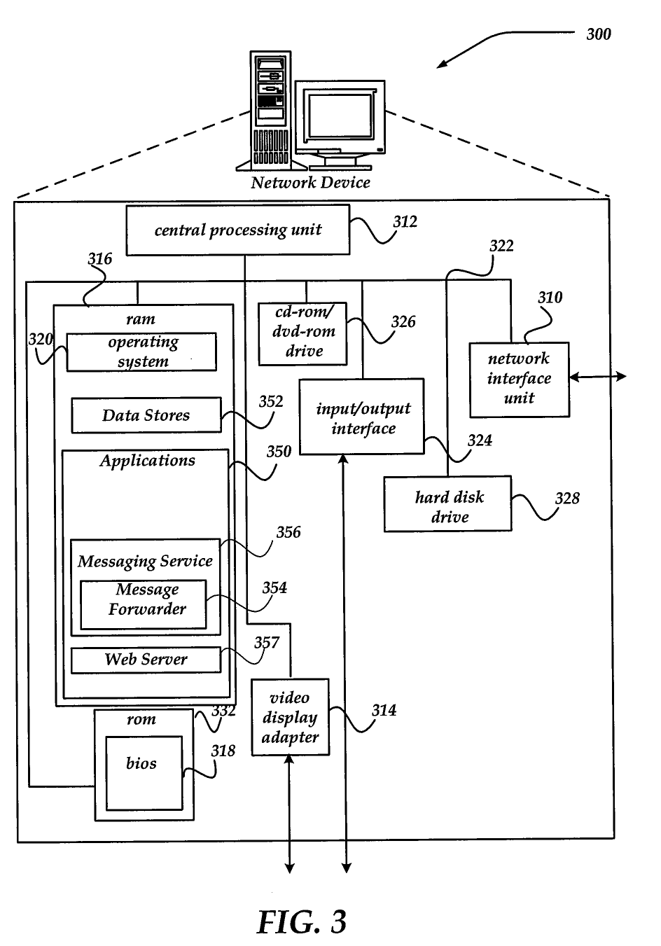

One embodiment of MFS 108 is described in more detail below in conjunction with FIG. 3. Briefly, however, MFS 108 may include any computing device capable of connecting to network 106 to enable a user to manage message forwarding between different accounts. In one embodiment, such message forwarding is also between different client devices, which may be managed by different users, system administrators, business entities, or the like.

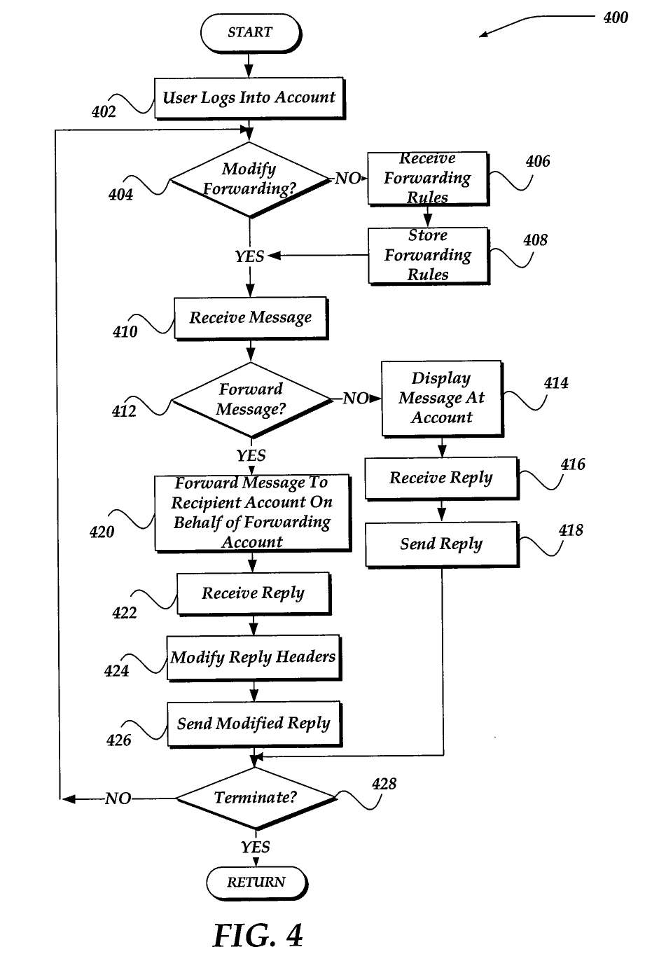

MFS 108 may enable a user to configure various message forwarding rules for one or more messaging accounts. Such rules may include, but are not limited to, selecting which messages to be forwarded based, at least in part, on a message sender's address, alias, account identifier, or the like. In one embodiment, MFS 108 enables users to identifier groups of message senders and to provide one or more forwarding rules for a given group of message senders. For example, the user might identify a family group, work team group, friends group, lunch buddy group, manager group, or the like. MFS 108 further allows the user to identify a recipient account to which one or more messages are to be forwarded. When a message is received, MFS 108 examines the message forwarding rules and determines whether to forward the message or not. If the message is to be forwarded, MFS 108 may forward the message to the designated recipient account on behalf of the forwarding account for the user. Reply messages may be modified by MFS 108 such that the recipient of the reply sees the message as having been sent by the forwarding account rather than the recipient account. In this way, users may maintain availability even when they are away from their own client devices. Moreover, they can still be available to identified message senders without requiring that the message sender be aware of location and/or client device changes by the user. Moreover, because the messages are received by the recipient account on behalf of the forwarding account, the user need not log into the recipient account's messenger. Moreover, the user need not launch multiple different messenger programs, different messenger accounts, or the like, at the recipient's client device. In one embodiment, the recipient account may be configured to accept forwarded messages. This may be quickly performed by the user of the recipient account when a forwarded message is received, and/or prior to receiving a forwarded message. In any event, MFS 108 may employ a process such as described in more detail below in conjunction with FIG. 4 to perform at least some of its actions.

Devices that may operate as MFS 108 include various network devices, including, but not limited to personal computers, desktop computers, multiprocessor systems, microprocessor-based or programmable consumer electronics, network PCs, servers, network appliances, and the like.

It is noted that while MFS 108 is illustrated as a single network device, the invention is not so limited. For example, in another embodiment, a messaging component, or the like, of MFS 108 may reside in one network device, while a message forwarding component might reside in another network device. In still another embodiment, various messaging and/or message forwarding components might reside in one or more client devices, operate in a peer-to-peer configuration, or the like.

### Illustrative Client Device

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one embodiment of at least one of client devices 101-105 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general purpose operating system such as a version of UNIX, or LINUX™, or a specialized client communication operating system such as, for example, Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by client device 200 to store, among other things, applications 242 and/or other data. For example, data storage 244 may also be employed to store information that describes various capabilities of client device 200. The information may then be provided to another device based on any of a variety of events, including being sent as part of a header during a communication, sent upon request, or the like. Moreover, data storage 244 may also be employed to store social networking information including address books, buddy lists, aliases, user profile information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, RSS feeds, and/or the like. For example, in one embodiment, messenger 243 may be configured as an IM messaging application, such as AOL Instant Messenger, Yahoo! Messenger, .NET Messenger Server, ICQ, or the like. In another embodiment, messenger 243 may be a client application that is configured to integrate and employ a variety of messaging protocols. In one embodiment, messenger 243 may interact with browser 245 for managing messages.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may represent, for example, MFS 108 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer-readable storage media. Computer-readable storage media may include volatile, nonvolatile, removable, and non-removable media implemented in any method or technology for storage of information, such as computer readable instructions, data structures, program modules, or other data. Examples of computer readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

As shown, data stores 352 may include a database, text, spreadsheet, folder, file, or the like, that may be configured to maintain and store user account identifiers, email addresses, IM addresses, and/or other network addresses; account message forwarding rules; group identifier information; or the like. In one embodiment, at least some of data store 352 might also be stored on another component of network device 300, including, but not limited to cd-rom/dvd-rom 326, hard disk drive 328, or the like.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, SMS message servers, IM message servers, email servers, account managers, and so forth. Web server 357 and messaging server 356 may also be included as application programs within applications 350.

Web server 357 represent any of a variety of services that are configured to provide content, including messages, over a network to another computing device. Thus, web server 357 includes for example, a web server, a File Transfer Protocol (FTP) server, a database server, a content server, or the like. Web server 357 may provide the content including messages over the network using any of a variety of formats, including, but not limited to WAP, HDML, WML, SMGL, HTML, XML, cHTML, xHTML, or the like. In one embodiment, web server 357 may be configured to enable a user to access and manage messages through messaging server 356.

Messaging server 356 may include virtually any computing component or components configured and arranged to forward messages from message user agents, and/or other message servers, or to deliver messages. Thus, messaging server 356 may include a message transfer manager to communicate a message employing any of a variety of messaging protocols, including, but not limited, to SMS messages, IM, MMS, IRC, RSS feeds, mIRC, any of a variety of text messaging protocols, or any of a variety of other message types. In one embodiment, messaging server 356 may enable users to initiate and/or otherwise conduct chat sessions, VOIP sessions, text messaging sessions, or the like.

In any event, message forwarder 354 is configured to enable users to manage message forwarding. Thus, message forwarder 354 may provide a user with one or more user interfaces that enable a user to specify one or more recipient accounts to which a message may be forwarded. In one embodiment, message forwarder 354 may allow the user to specify which messages are to be forwarded based on a group identifier for which a message sender is a member, a message sender's identifier, or the like. Message forwarder 354 may further allow users to cancel message forwarding, and/or further modify such message forwarding. Such forwarding rules may be stored by message forwarder 354 in data stores 352.

The forwarding rules may be configured by a user to maintain privacy and enable urgency of communications as appropriate. That is, for example, where a worker might be working on another's client device, but remembers that their manager intends to send an IM message, the worker may employ forwarding rules specific to the manager. If the worker selects to log into the worker's own IM account, many messages might be received from other than the worker's manager, and thus potentially distract the worker from a given task. If the worker employs forwarding rules specific to the manager's messages, then selective IM messages will be forwarded, minimizing interruptions for the worker.

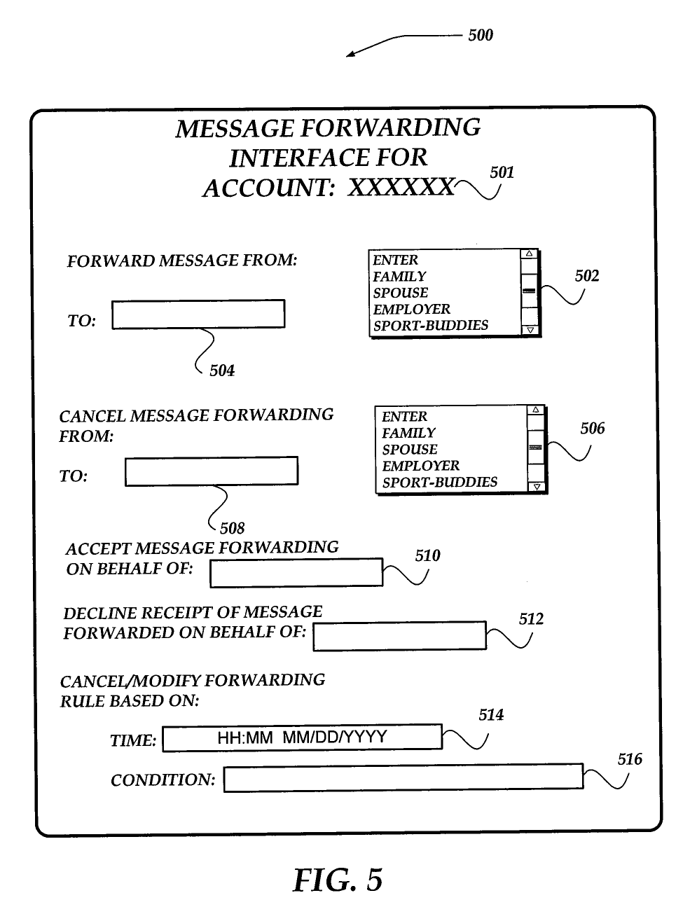

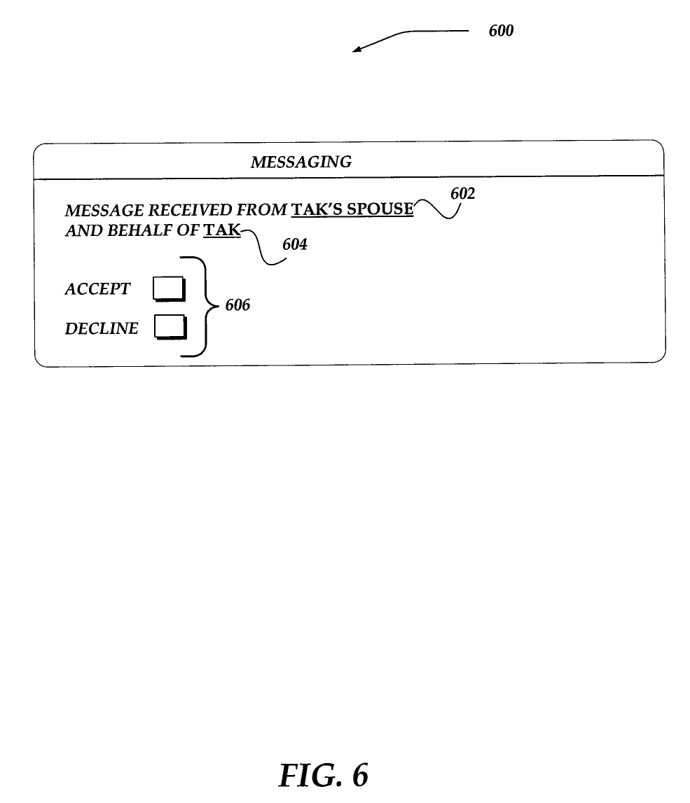

When messages are received by messaging service 356, message forwarder 354 may examine the message to determine whether to forward the message to a recipient account. If so, message forwarder 354 may then manage such forwarding, and/or provide information to messaging service 356 to enable such message forwarding. In one embodiment, messaging service 356 enables the messages to be forwarded to the recipient account on behalf of the forwarding account. In one embodiment, where the messages are associated with an IM chat session, or the like, once the session is accepted, messages may be exchanged on behalf of the forwarding account through use of the chat session, or the like. However, in one embodiment, message replies may be modified by message forwarder 354 such that the replies appear as though they are being sent by the forwarding account. In one embodiment, message forwarder 354 may employ a process such as described below in conjunction with FIG. 4 to perform at least some of its functions. Moreover, message forwarder 354 may employ user interfaces, among others, such as described below in conjunction with FIGS. 5-6.

In any event, use of message forwarder 354 is directed towards providing messaging flexibility to the user. That is, users can selectively forward messages to different accounts, as well as to different client devices. For example, in one embodiment, a user might select to have only family members, and/or selective friends send messages to their mobile device. User of message forwarder 354 enables the user then to configure selective forwarding rules for the mobile device for selective message senders, and have other message senders' messages sent to a different client device.

### Generalized Operation

The operation of certain aspects of the invention will now be described with respect to FIG. 4. FIG. 4 illustrates a logical flow diagram generally showing one embodiment of an overview process for managing message forwarding for a forwarding account to another selectable account. Process 400 may be implemented within MFS 108 of FIG. 1, such that various client devices may forward messages to another client device, other account, or the like.

Process 400 begins, after a start block, at block 402, where a user logs into their account. In one embodiment, the user may instead of logging into their account, provide other information as evidence that they own the account.

Processing then flows to decision block 404, where a determination is made whether the user request to modify message forwarding rules. In one embodiment, the user might provide such indication by selecting an option on an interface menu, selecting a widget, or using any of a variety of other section mechanisms. If the determination is that the user requests modification of message forwarding rules, processing flows to block 406; otherwise, processing flows to block 410.

At block 406, the user may select a variety of forwarding rules. For example, the user may select to forward messages received from an individual, someone identified within a group, or the like. The user may further specify an account for which messages are to be forwarded. As noted elsewhere, the specified account to receive the forwarded messages is known as the recipient account, while the user's account for which messages are to be forwarded is known as the forwarding account. In still another embodiment, the user may specify messages to be forwarded selectively to a specified client device, such as their mobile device, or the like. In one embodiment, specification of the client device may be obtained by specifying a network address, or other unique identifier associated with the client device. For example, where the client device is a mobile phone, then the user might specify a phone number for the mobile phone. In another embodiment, however, the user might select a particular account for which the user might also own, and employ that particular account as the recipient account. The user may then specify messages from selected message senders to be sent to that particular account. The user may then monitor that particular account from a specific client device, such as their mobile phone, or the like.

At block 406, the user may further select to cancel one or more forwarding rules. In another embodiment, the user may further specify that they are willing to accept messages forwarded from a forwarding account on behalf of the forwarding account. In still another embodiment, the user may select, at block 406, to decline receipt of forwarded messages from one or more forwarding accounts. Thus, at block 406 the user may provide a variety of different forwarding rules for managing message forwarding between messaging accounts. In one embodiment, the user might employ an interface, such as described in more detail below in conjunction with FIG. 5 to manage their forwarding rules. In at least one embodiment, at least some of the blocks illustrated in process 400, may be performed distinct from other blocks. For example, blocks 406 and 408 might be performed as part of a configuration/setup sub-process, distinct from a use sub-process. Thus in one embodiment, blocks 406 and 408 might be performed by the user at one client device prior to relocating to another client device. The other blocks illustrated subsequent to blocks 406 and 408 might then be performed while the user is at the other client device. However, the invention is not restricted to this use case, and other use cases may also be applied.

Processing then flows to block 408, where the received one or more forwarding rules for the user's account may be stored. In one embodiment, at this juncture, the user may select to log out of their account. Processing continues next to block 410.

At block 410, a message may be received for the user's account. Processing flows next to decision block 412, where a determination is made whether the message is to be forwarded based on the stored forwarding rules. In one embodiment, some messages may be forwarded to one recipient account, where other messages might be forwarded to a different recipient account. In still another embodiment, at least some messages might be designated not to be forwarded. In still another embodiment, the message might be forwarded based on a unique client device identifier. In one embodiment, the determination may be based on information about the message sender, such as the message sender's alias, account identifier, network address, whether the message sender is a member of a defined group where the group is collectively designated to be forwarded or not, or the like. If the message is to be forwarded, processing flows to block 420; otherwise, processing flows to block 414.

At block 414, the message is made accessible in a message window, or similar user interface, associated with the user's account for which the message sender designated. That is, the message is not forwarded. For example, the message may be a text message that initiates a chat session. The user may accept the message, open the chat session, and read the message. The user may then, at block 416, prepare and send a reply to the message. Continuing to block 418, the reply may then be sent to the message sender. Processing flows next to decision block 428.

At block 420, the forwarding rules are employed to forward the message to the designated recipient account on behalf of the forwarding account. In one embodiment, a message screen may appear at a client device for the forwarding account, indicating that a message is received on behalf of the forwarding account. One embodiment, of a non-limiting example of a screen display useable to indicate such a message being received is described in more detail below in conjunction with FIG. 6. In any event, acceptance of the forwarded message may initiate a chat session, or other messaging session, using the recipient account. Thus, in one embodiment, a chat messaging client on the client device may provide an interface for which the forwarded message may be displayed, and to which the forwarding user may provide a reply.

Moreover, at block 420, the user typically has logged off of their forwarding account, and now receives the forwarded messages through the recipient user's recipient account. Such activities may occur at a different client device from which the user configured their forwarding rules; however, the forwarding user might also employ the recipient user's client device to access their account and configure their forwarding rules.

Processing continues to block 422, where the user may prepare and send a reply to the received message, the reply being received at block 422, for example, by MFS 108 of FIG. 1, in one embodiment. Continuing to block 424, a reply header and/or other information within the reply may be modified, such that the reply is configured to appear as though it was sent from the forwarding account rather than from the recipient account. Moving to block 426, the modified reply may then be sent towards the message sender's account.

Processing flows next to decision block 428, where a determination is made whether the messaging session is to be terminated. If so, processing returns to a calling process; otherwise, processing loops back to decision block 404.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions.

### Illustrative Example Screen Shots

The operation of certain aspects of the invention will now be described with respect to various screen displays shown in FIGS. 5-6. The various screen displays of FIGS. 5-6 may include many more or less components than those shown. However, the components shown are sufficient to disclose an illustrative embodiment for practicing the present invention.

FIG. 5 illustrates one embodiment of a non-limiting, non-exhaustive example menu interface 500 useable to manage message forwarding by entering various forwarding rules. As shown, menu interface 500 includes a capability for a user to select one or more message senders 502 from which to forward messages based on forwarding rules for a given account 501. Although not illustrated, a user may specify the account 501 for which the forwarding rules apply by performing any of a variety of actions. For example, the user might log into the account for which the forwarding rules are to be applied. However, in another embodiment, the user might enter a account identifier into account 501 field. The user might then be asked to provide information to authenticate the user's ownership of the account. In one embodiment, the user might also be enabled to enter a plurality of accounts into account 501 field, thereby providing forwarding rules to the plurality of different accounts.

The user may enter a single message sender address, and/or identify one or more message sender groups. The user may further specify the message recipient account field 504. In one embodiment, the user may enter in message recipient account field 504 a unique client device identifier, such that messages may be directed to a client device.

Menu interface 500 also includes, is a capability to allow the user to cancel message forwarding based on identified message senders 506. The user may further cancel the forwarding to a specified message recipient account using field 508.

Menu interface 500 further includes a capability to allow the user to accept message forwarding on behalf of a forwarding account, by entering the forwarding account identifier into field 510. By accepting message forwarding using field 510, the user might provide recipient account rules that may, in one embodiment, minimize acceptance of forwarded messages when the message is received. Similarly, the user may select to decline to accept messages forwarded by a forwarding account by entering the forwarding account identifier into field 512.

A user may also change or cancel a forwarding rule based on an entry of a time expiration 514, and/or some other condition 516.

Thus, users may create a variety of forwarding rules. Non-limiting, non-exhaustive examples of forwarding rules using Menu interface 500 might include:

For “home” account—forward messages from “family” group, and “spouse” to “work” account.

For “work” account—forward messages from “my team” group, and “boss” to “friend” account with a two hour expiration.

For “work” account—forward “all” messages to “home” account if (“work” account login is false). That is, if the user is not logged into their work account, then forward any messages to their home account.

Clearly, many other forwarding rules may be created, and thus, such examples are not to be construed as limiting or otherwise narrowing the invention.

FIG. 6 illustrates one embodiment of an example message interface 600 for forwarded messages received on behalf of a forwarding account. Menu interface 600 may represent one example of a screen display pop-up, or the like, that may appear at the recipient account's client device when a message is forwarded to that recipient account. In one embodiment, menu interface 600 may indentify the forwarding account 604 and the message sender's identifier 602. In one embodiment, menu interface 600 may allow the user or the ‘host’ of the recipient account to accept/decline the forwarded message using one of the selection indicators 606.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, including:
providing, at a first client device, a menu interface for managing forwarding rules for a text message;
receiving a forwarding rule from the user, wherein the forwarding rule identifies at least a recipient account for which the text message is to be forwarded, the recipient account being different from a forwarding account to which the text message is sent;
receiving the text message sent to the forwarding account;
based on the forwarding rules, forwarding the received text message to the recipient account on behalf of the forwarding account;
receiving a reply to the text message at the recipient account;
modifying a header of the reply such that the reply appears to have been sent from the forwarding account; and
forwarding the modified reply to a sending account associated with the text message.

2. The network device of claim 1, wherein the forwarding rules further include at least one condition upon satisfaction of which automatically cancels the forwarding of another text message to the recipient account.

3. The network device of claim 1, wherein the forwarding rules include information indicating that any text message from a member of a designated group is to be forwarded to the recipient account.

4. The network device of claim 1, wherein the recipient account is owned by a different user than the user associated with the forwarding account.

5. The network device of claim 1, wherein the forwarding rules includes information indicating that text message is to be forwarded to a particular client device.

6. The network device of claim 1, wherein the processor is operative to perform actions, including:
establishing a chat session between the sending account and the recipient account on behalf of the forwarding account.

7. A system that is operative to manage communications over a network, comprising:
a client device that is configured to perform actions:
logging a user into a messaging account;
providing forwarding rules for a message from a sender account, the messaging account further being identified as a forwarding account and the forwarding rules designating a recipient account to which the message is to be forwarded; and
a network device that is configured to perform actions:
receiving the message sent to the forwarding account from the sender account;
forwarding the received message to the recipient account on behalf of the forwarding account based on the forwarding rules;
receiving a reply to the text message at the recipient account;
modifying a header of the reply such that the reply appears to have been sent from the forwarding account; and
forwarding the modified reply to a sending account associated with the text message.

8. The system of claim 7, wherein the recipient account is activated on a different client device from the forwarding account.

9. The system of claim 7, wherein the forwarding rules includes a condition upon satisfaction of which terminates forwarding of a subsequent message from the sender account.

10. The system of claim 7, wherein the sender account is a designated in the forwarding rules as a member of a group.

11. The system of claim 7, wherein the network device establishes an instant messaging chat session for the message and the reply.

12. The system of claim 7, wherein the recipient account is configurable to decline receipt of the text message on behalf of the forwarding account.

13. The system of claim 7, wherein the forwarding rules include at least one condition for canceling forwarding of messages from the forwarding account, the condition being associated with an expiration of a time.

14. The system of claim 7, wherein the network device is configured to perform actions, further including:
receiving another message, the other message being received from a different sender account;
determining, based on the forwarding rules, that the other message is not to be forwarded to the recipient account, and instead sending the other message to the forwarding account.

15. A computer-readable storage medium having computer-executable instructions, the computer-executable instructions when installed onto a computing device enable the computing device to perform actions, comprising:
receiving the text message sent to a forwarding account for messaging;
based on forwarding rules, forwarding the received text message to a recipient account on behalf of the forwarding account;
receiving acceptance of the forwarded message by the recipient account;
initiating a messaging session;
receiving a reply to the text message at the recipient account within the messaging session;
modifying a header of the reply such that the reply appears to have been sent from the forwarding account; and
forwarding the modified reply to a sending account associated with the text message.

16. The computer-readable storage medium of claim 15, wherein the text message is received from a sender account that is identified within the forwarding rules to be a member of a group for which messages are to be forwarded.

17. The computer-readable storage medium of claim 15, wherein the computing device performs actions, further comprising:
receiving another text message sent to the forwarding account;
determining, based on the forwarding rules, that the other text message is not to be forwarded; and
sending the other text message to the forwarding account.

18. The computer-readable storage medium of claim 15, wherein the forwarding rules includes at least one of a condition or a time upon satisfaction of which expires the forwarding rules, such that another message sent to the forwarding account is not forwarded to the recipient account.

19. The computer-readable storage medium of claim 15, wherein the forwarding account and the recipient account are managed by a same user.

20. The computer-readable storage medium of claim 15, wherein the forwarding rules further specify forwarding the message to a specific client device.
